(19) United States
(12) Patent Application Publication
(10) Pub. No.: US 2010/0181960 A1
(43) Pub. Date: Jul. 22, 2010

(54) RECHARGEABLE POWER SUPPLY DEVICE HAVING AN IDENTIFICATION DEVICE

(76) Inventor: Wolf Matthias, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/666,200

(22) PCT Filed: May 5, 2008
(86) PCT No.: PCT/EP08/55457

§ 371 Date: Dec. 22, 2009

(30) Foreign Application Priority Data
Jun. 27, 2007 (DE) 10-2007-029-746.9

(51) Int. Cl. H02J 7/00

(52) U.S. Cl. 320/106

(57) ABSTRACT

The invention relates to a rechargeable power supply device for supplying power to an electrical appliance. The rechargeable power supply device is provided with at least one chip on which data for identification of the power supply device can be stored, and can be read by the electrical appliance and/or by a charger.

### PRIOR ART

The invention relates to a rechargeable power supply device, such as a rechargeable battery pack or nonrechargeable battery pack, which supplies an electrical device with energy and is provided with an identification device.

From the prior art, mechanical coding is known in which coding ribs are furnished, so that only the right battery packs fit into the associated device. However, this has the disadvantage that only certain devices can work together.

Electrical coding by means of coding resistors is also known from the prior art. In it, one additional contact, to which a certain resistance is switched in the rechargeable battery, is evaluated by a device and thus a conclusion is drawn about the corresponding characteristic electrical data. This has the disadvantage that the electrical coding with resistors makes only a certain number of codes possible. Future compatibility is limited, since the corresponding parameter sets in the device during the readout have to be defined at the outset.

Electrical coding via a data bus (BBS 36V System) is also known from the prior art. In it, via one additional data contact, the device and the rechargeable battery exchange the required information by means of defined transmission protocols. It is true that the bus system compensates for the disadvantage of electrical coding by means of resistors, since the rechargeable battery can forward even parameter values not known beforehand. However, the bus system has the disadvantage that nevertheless, additional contacts are required, for which the rechargeable battery furthermore requires its own smart electronics.

According to the present invention, as claimed in claim 1, a rechargeable power supply device for supplying energy to an electrical device is furnished in which the power supply device is provided with at least one chip as an identification device. On the chip, data for identifying the power supply device can be stored in memory and read out by the electrical device and/or a charger.

Advantageous embodiments of the invention are recited in the dependent claims.

In one advantageous embodiment, data, such as the current limits, internal resistances, and voltage level, can be stored in memory and updated on the chip. This has the advantage that data and information can be stored in memory on the chip even retroactively, for instance data not yet known at the time the power supply device was made or that have changed since then.

In a further embodiment according to the invention, additional data can be stored in memory on the chip, such as the production date and/or the batch number. This has the advantage that in the event of a defective power supply device, its production can be tracked precisely, and problems in the production process, for instance, can be discovered more easily.

In a further embodiment according to the invention, the chip is an RFI chip, for example. Such a chip has the advantage that it can be read out in contactless fashion via radio waves, without requiring a separate electrical contact on the associated electrical device or charger.

In a further embodiment, the chip, with its data stored in memory on it, can be updated by reprogramming the chip.

Exemplary embodiments of the invention are described in further detail below in conjunction with the schematic FIGURE of the drawing.

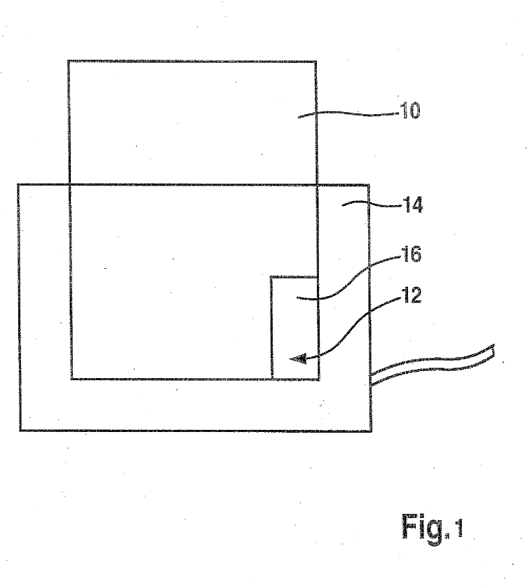

FIG. 1 shows a schematic view of one embodiment of a rechargeable power supply device 10 according to the invention, which is provided with an identification device 12 and is disposed in a charger 14.

In FIG. 1, a highly simplified view is shown of a rechargeable power supply device 10 of the invention and of a charger 14. The power supply device 10 is for example a rechargeable battery pack or a nonrechargeable battery pack.

Below, the rechargeable power supply device 10 according to the invention will be described in conjunction with a rechargeable battery, or a rechargeable battery pack. Such rechargeable battery packs must often be identified, in terms of their electrical properties, to electrical devices or chargers 14. For instance, a charger 14, especially a high-speed charger, must know the current limits with which it can load a rechargeable battery pack. In the case of lithium-ion rechargeable battery packs, a charger 14 must for instance know the precise voltage at which the charging operation must be terminated.

For this purpose, the invention furnishes a rechargeable battery pack 10, as a rechargeable power supply device, which is provided with a chip 16. The chip 16 is provided, for instance at the end of assembly, with the characteristic data for the rechargeable battery pack 10 on the basis of which the rechargeable battery pack 10 can be identified by an electrical device or a charger 14. To that end, the chip 16 is programmed accordingly. In that process, data, such as the voltage at which the charging operation is terminated, can be stored in memory.

Selectively, additional data, such as the production date, the batch number, and so forth, can be stored in memory as well. The associated electrical device or charger can, without an additional electrical contact, read out the data for the rechargeable battery pack 10 later from the chip 16. As the chip 16, a so-called RFI chip is used, for instance. An RFI chip of this kind forms a kind of transponder. The transponder comprises the chip or microchip, an antenna, a substrate or housing, and an energy source (in the case of active transponders).

Small battery-free RFID transponders exist that have no power supply of their own. They can obtain their supply voltage for the microchip by induction, for instance, from the radio signals of a base station. An RFID transponder of this kind can be used for identifying a rechargeable battery pack. RFID transponders with their own power supply have the energy for supplying the microchip from a built-in battery.

Such RFID transponders or RFI chips have the advantage that they require no electrical contact of their own on the charger 14 or electrical device in order to read out the chip 16, since the identification is done here via radio waves. In other words, the RFID makes contactless reading operations without direct visual contact possible.

It is also possible for parameters, such as the current limits, internal resistances, voltage levels, and so forth, that were not yet known at the time when the electrical device or the power supply device was made, to be stored in memory or updated on the chip 16. These data can be transmitted to the chip 16 and evaluated correctly. The invention is not limited to the data mentioned above. In principle, arbitrary data can be stored in memory on the chip 16 as an identification device and called up again later, in accordance with the function and intended use.

1-6. (canceled)

7. A rechargeable power supply device for supplying energy to an electrical device, the rechargeable power supply device being provided with at least one chip, on which data for identifying the power supply device can be stored in memory and read out by the electrical device and/or a charger.

8. The rechargeable power supply device as defined by claim 7, wherein the data for identifying the power supply device, such as current limits, internal resistances, and voltage level, can be stored in memory and updated on the chip.

9. The rechargeable power supply device as defined by claim 7, wherein further additional data, such as production date and/or batch number, can be stored in memory on the chip.

10. The rechargeable power supply device as defined by claim 8, wherein further additional data, such as production date and/or batch number, can be stored in memory on the chip.

11. The rechargeable power supply device as defined by claim 7, wherein the chip is an RFI chip.

12. The rechargeable power supply device as defined by claim 8, wherein the chip is an RFI chip.

13. The rechargeable power supply device as defined by claim 9, wherein the chip is an RFI chip.

14. The rechargeable power supply device as defined by claim 10, wherein the chip is an RFI chip.

15. The rechargeable power supply device as defined by claim 7, wherein the chip, with the data stored in memory thereon, can be updated by reprogramming the chip.

16. The rechargeable power supply device as defined by claim 8, wherein the chip, with the data stored in memory thereon, can be updated by reprogramming the chip.

17. The rechargeable power supply device as defined by claim 9, wherein the chip, with the data stored in memory thereon, can be updated by reprogramming the chip.

18. The rechargeable power supply device as defined by claim 10, wherein the chip, with the data stored in memory thereon, can be updated by reprogramming the chip.

19. The rechargeable power supply device as defined by claim 11, wherein the chip, with the data stored in memory thereon, can be updated by reprogramming the chip.

20. The rechargeable power supply device as defined by claim 14, wherein the chip, with the data stored in memory thereon, can be updated by reprogramming the chip.

21. The rechargeable power supply device as defined by claim 7, wherein the chip can be read by the electrical device or the charger without requiring an additional electrical contact on the electrical device or the charger for that purpose.

22. The rechargeable power supply device as defined by claim 8, wherein the chip can be read by the electrical device or the charger without requiring an additional electrical contact on the electrical device or the charger for that purpose.

23. The rechargeable power supply device as defined by claim 9, wherein the chip can be read by the electrical device or the charger without requiring an additional electrical contact on the electrical device or the charger for that purpose.

24. The rechargeable power supply device as defined by claim 11, wherein the chip can be read by the electrical device or the charger without requiring an additional electrical contact on the electrical device or the charger for that purpose.

25. The rechargeable power supply device as defined by claim 15, wherein the chip can be read by the electrical device or the charger without requiring an additional electrical contact on the electrical device or the charger for that purpose.

26. The rechargeable power supply device as defined by claim 20, wherein the chip can be read by the electrical device or the charger without requiring an additional electrical contact on the electrical device or the charger for that purpose.
